(19) United States
(12) Patent Application Publication
(10) Pub. No.: US 2008/0068149 A1
(43) Pub. Date: Mar. 20, 2008

(54) Modular seatbelt minder

(76) Inventors: Karl Kennedy, Fraser, MI (US); John F. Nathan, Highland Twp., MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/521,165

(22) Filed: Sep. 14, 2006

(51) Int. Cl. B60Q 1/00

(52) U.S. Cl. 340/457.1

(57) ABSTRACT

A vehicle restraint occupant sensing system is provided for detecting a presence of an unrestrained vehicle occupant in a vehicle seat. A seat belt restraint sensing circuit senses whether a seat belt is in an unlatched condition. An occupant sensing system includes at least one sensor assembly in spaced relation to a vehicle seat for sensing a presence of the occupant in the vehicle seat. The occupant sensing system includes a comparator circuit coupled to the at least one sensor assembly and the seat belt restraint sensing circuit for producing an output signal indicative of the presence of the occupant. A logic circuit is disposed within the vehicle seat coupled to an output of the comparator circuit and the seat belt restraint sensing circuit for providing an alert output signal when the seat belt is in the unlatched condition and the output signal indicates that the occupant is present.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates in general to vehicle safety devices, and more specifically, to a system for alerting a vehicle occupant of an unsecured safety restraint device.

2. Background of Related Art

Automotive vehicles employ safety restraint devices for the safety of passengers of the vehicle. The safety restraint systems restrain a vehicle occupant in a vehicle seat for protecting the occupant in the event of a collision. A primary vehicle restraint system commonly utilized in vehicles today is seatbelt restraint devices. Seatbelts usually include a lap belt and a shoulder belt that extends diagonally across the occupant's torso from one end of the lap belt to a mounting structure located proximate to the occupant's opposite shoulder.

Safety restraint systems typically provide a respective reminder signal generated by a safety harness monitoring device connected to a control module. In addition, a respective signal from a seat occupying monitoring device may also be provided to the control module. Prior to a controller acting upon the respective signals from the safety harness monitoring device and seat monitoring device, such signals are typically converted to digital signal by respective analog to digital (A/D) signal converters so that the controller may process the incoming signals. Typically, adding respective A/D signal converters solely for signal conversion for these respective monitoring devices adds complexity and cost to the vehicle safety system.

### BRIEF SUMMARY OF THE INVENTION

The present invention has the advantage of detecting a presence of one or more unrestrained vehicle occupants seated within the vehicle. The present invention further provides a pre-processed alert output signal to a safety restraint control module identifying an unrestrained vehicle occupant where the pre-processed signal requires no additional processing by the safety restraint control module for determining whether an unrestrained vehicle occupant is present. In addition, a resistance output circuit is provided for converting the alert output signal that is indicative of the presence of the unrestrained vehicle occupant to a resistance output value for alerting a safety control module.

In one aspect of the present invention, a vehicle restraint occupant sensing system is provided for detecting a presence of an unrestrained vehicle occupant in a vehicle seat. A seat belt restraint sensing circuit senses whether a seat belt is in an unlatched condition. An occupant sensing system includes at least one sensor assembly in spaced relation to a vehicle seat for sensing a presence of the occupant in the vehicle seat. The occupant sensing system includes a comparator circuit coupled to the at least one sensor assembly and the seat belt restraint sensing circuit for producing an output signal indicative of the presence of the occupant. A logic circuit is disposed within the vehicle seat coupled to an output of the comparator circuit and the seat belt restraint sensing circuit for providing an alert output signal when the seat belt is in the unlatched condition and the output signal indicates that the occupant is present.

In yet another aspect of the present invention, a method is provided for detecting an unrestrained vehicle occupant seated on a vehicle seat of a vehicle. A seat belt restraint sensing circuit, an occupant sensing circuit, and a logic circuit are provided. Each of the respective circuits are disposed adjacent a lower surface of the vehicle seat cushion. A seat belt is sensed for determining whether the seat belt is in an unlatched condition. A presence of the occupant in the vehicle seat is sensed. A determination is made in the logic circuit whether a vehicle occupant is unrestrained in response to the sensing an unlatched seat belt while the presence of the occupant in the vehicle seat is sensed. An alert output signal is output to a controller module remote from the vehicle seat indicative of an unrestrained vehicle occupant.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an interior vehicle seat monitoring system of the present invention.

FIG. 2 is a block diagram of a belt alert monitoring system according of the present invention.

FIG. 3 is a schematic diagram of a belt alert monitoring system of the present invention.

FIG. 4 is a logic table for the logic circuit shown in FIG. 3.

### DETAILED DESCRIPTION OF THE PREFERRED EMBODIMENT

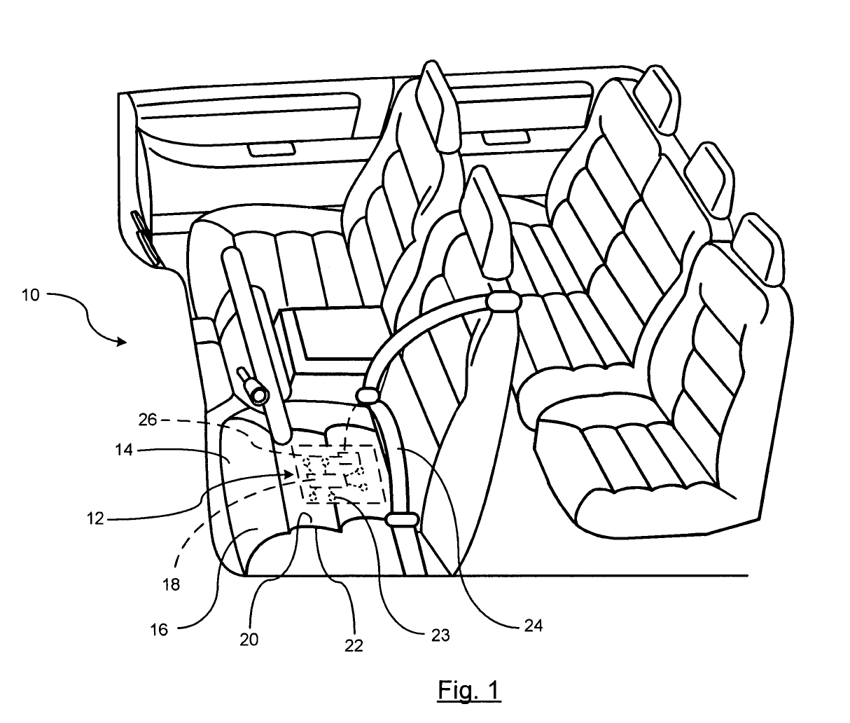

Referring now to the drawings, there is illustrated in FIG. 1 a vehicle 10 having a safety restraint alert system is shown generally at 12. The safety restraint alert system 12 is disposed adjacent a lower surface of the vehicle seat cushion 14 of a vehicle seat 16 for variably sensing a displacement of the vehicle seat cushion 14 for identifying a presence of the occupant in the vehicle seat 16. It is understood that the safety restraint alert system 12, although shown only in the driver vehicle seat, may be utilized in each passenger seat of the vehicle 10.

The safety restraint alert system 12 includes an occupant sensing system 18 for sensing a vehicle occupant seated within the vehicle seat 16. Preferably, the vehicle occupant sensing system 18 is similar to the occupant sensing system disclosed in co-pending patent application Ser. No. 11/400,477 entitled Seatbelt Minder, and filed Apr. 7, 2006, which is herein incorporated by reference in its entirety. The vehicle seat cushion 14 has an upper seating surface 20 and a lower or downwardly facing surface 22. The seat cushion 14 can be formed of any suitable layers of material, such as a foam layer and an outer trim material, which permit the transfer of the force from an object resting on the cushion to be transferred to a plurality of sensor assemblies 23, such as a mat sensor array assembly.

The plurality of seat sensor assemblies 23 is disposed adjacent the lower surface 22 of the vehicle seat cushion 14. The plurality of sensor assemblies 23 may be positioned at any suitable position adjacent the seat cushion 14 which enables forces from the weight of an occupant on the seat cushion 14 acting on the upper seating surface 20 to be transferred through the seat cushion 14 and onto the plurality of sensor assemblies 23. Preferably, the plurality of sensor assemblies 23 includes a flexible printed circuit board. The plurality of sensor assemblies 23 defines a plurality of mounting locations for mounting each of the sensors. It should be understood that the plurality of sensor assemblies can be mounted on a mat array in any suitable manner. Alternatively, the plurality of sensor assemblies 23 may be formed on a rigid material, such as plastic, to provide a generally rigid structure for mounting and positioning the plurality of sensor assemblies 23 relative to one another can employ any number of sensor assemblies mounted thereto. In addition, the plurality of sensor assemblies 23 may be positioned at various locations on the mat array to sense one or more regions and may also include different configurations.

The vehicle 10 further includes a safety restraint device 24, such as a seat belt, for securing a vehicle occupant to the vehicle seat 16. The safety restraint device 24 may be monitored for determining that the vehicle occupant is secured within the vehicle seat 16. A vehicle restraint monitoring device 26 may monitor the safety restraint device 24 to determine when the safety restraint device 24 is in a latched condition or unlatched condition. The sensed output signals from the occupant sensing system 18 and the restraint monitoring device 26 cooperatively determine whether an occupant is located within the vehicle seat 16 and whether the occupant is unrestrained.

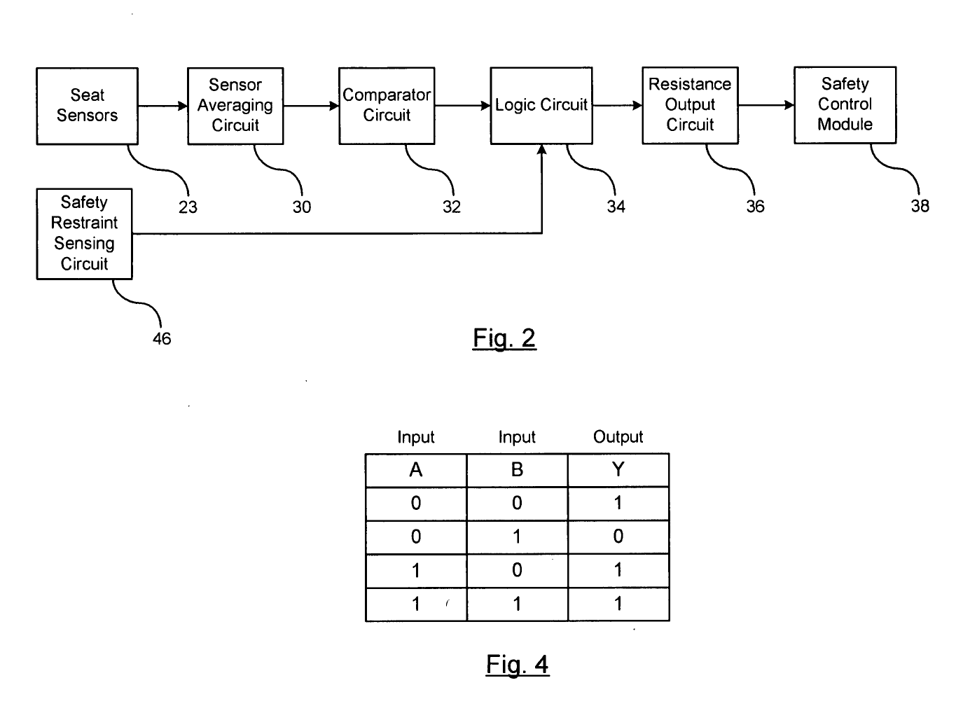

FIG. 2 illustrates a block diagram of a safety restraint alert system. Input signals from the plurality of sensor assemblies 23 are provided to a sensor averaging circuit 30. The sensor averaging circuit 30 may be part of a microchip integrated as part of the sensor assemblies 23 (i.e., the mat array). The sensor averaging circuit 30 is configured to generate an average value of the combined input signals and output an averaged output signal. Alternatively, the plurality of sensor assemblies 23 may be provided to a summing circuit similar to that disclosed in co-pending patent application Ser. No. 11/400,477 for generating a summed output signal. The averaged output signal is provided to a comparator circuit 32 where a determination is made whether the averaged output signal is above a predetermined threshold. A resulting output signal based on whether the averaged output signal is above or below the threshold is provided to a logic circuit 34.

The vehicle restraint monitoring device 26 (shown in FIG. 1) senses whether the safety restraint device 24 (shown in FIG. 1) is in a latched or unlatched condition. Based on the resulting determination, a resulting safety restraint signal which is indicative of a latched or unlatched condition (of the safety restraint device) is provided to the logic circuit 34. A logic operation is performed on the resulting output signal and safety restraint signal for determining whether an unrestrained vehicle occupant is seated within the vehicle seat 16 (shown in FIG. 1). If a vehicle occupant is determined to be unrestrained, then an alert output signal is output from the logic circuit 34 indicating the presence of the unrestrained vehicle occupant seated within the vehicle.

Preferably, the alert output signal is provided to a resistance output circuit 36 for converting the alert output signal (voltage) to a resistance output value. The resistance output value may either be a high resistance value or a low resistance value. A low resistance value indicates that an unrestrained vehicle occupant is seated within the vehicle seat. A high resistance value indicates that either a restrained vehicle occupant is present or that no occupant is present, which in either event, does not require an unrestrained occupant alert condition. The resistance output value is preferably provided to a safety control module 38 (i.e., safety restraint module) for identifying the unrestrained vehicle occupant so that an alert warning may be provided. The safety control module 38 may include any module which provides precautionary measures for alerting the vehicle occupant of the unrestrained condition such as an airbag module. Alternatively, the alert output signal output from the logic circuit 34 may be provided directly to the safety control module 38.

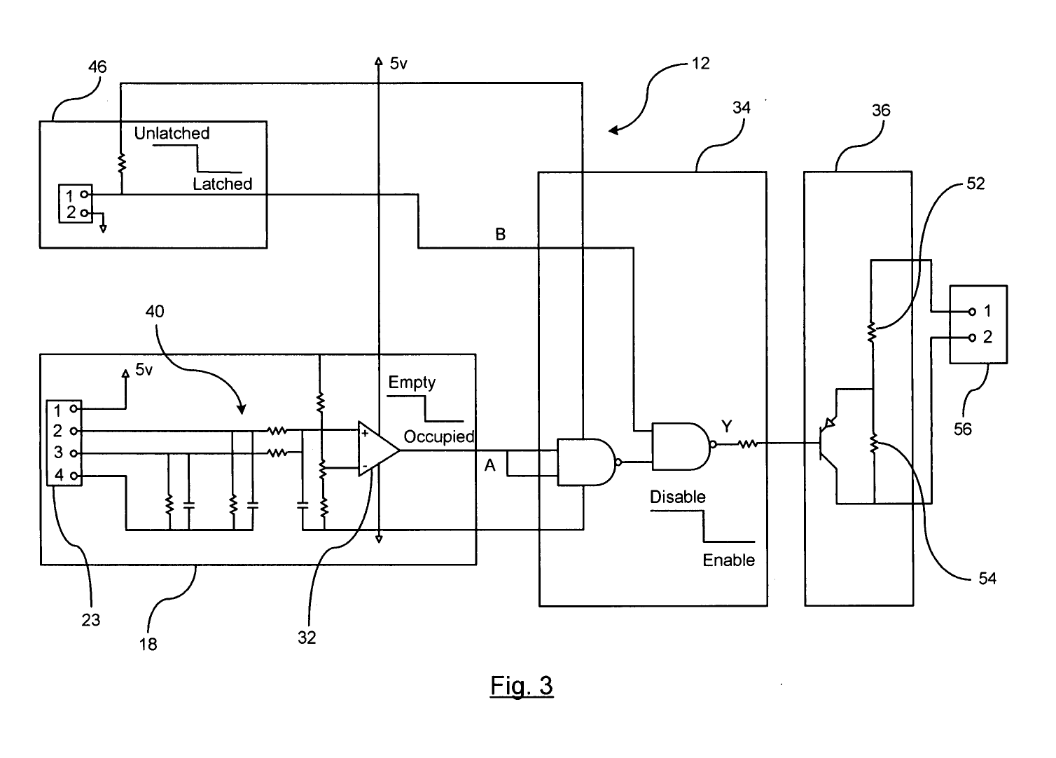

FIG. 3 illustrates a schematic of the belt alert system 12. The occupant sensing system 18 includes the plurality of sensor assemblies 23 and an occupant sensing circuit 40. The occupant sensing circuit 40 includes a plurality of sub-circuits for determining a vehicle occupant seated within the vehicle seat. In a preferred embodiment, the occupant sensing circuit 40 averages the sensed output signals from the plurality of sensor assemblies 23. Alternatively, the occupant sensing circuit 40 may include a summing circuit for generating a summed sensed output signal. The averaged output signal is coupled to a comparator circuit 32 where the averaged sensed output signal is compared to a respective known voltage for determining whether an occupant is seated within the sensed vehicle seat.

The resulting output signal is produced by the comparator circuit 32 which is indicative of the presence of the vehicle occupant in the vehicle seat 16 (shown in FIG. 1). The resulting output signal is provided from the comparator circuit 32 to a logic circuit 34. The logic circuit 34 is also connected to a seat belt restraint sensing circuit 46 disposed in the restraint monitoring device 26. The logic circuit 34 receives the input signals from the comparator circuit 32 and the restraint sensing circuit 46. Based on the combination of the received signals, the logic circuit 34 outputs an alert output signal when the resulting output signal from the comparator circuit 32 indicates the presence of an occupant seated within the vehicle seat and the output signal from the restraint sensing circuit indicates the safety restraint is in the unlatched condition. Preferably, the output signal generated by the comparator circuit is a 0 volt signal for indicating the presence of the occupant in the vehicle seat or a 5 volt signal for indicating no occupant in the vehicle seat (or a restrained occupant). Similarly, the output signal generated from the restraint sensing circuit is a 0 volt signal indicating a seat belt latched condition or a 5 volt signal indicating a seat belt unlatched condition.

The logic circuit 34 performs a logic operation on the received input signal for outputting the alert output signal. This will typically include a high logic voltage (5 volts) or a low logic voltage (0 volts). Only the determination of both the vehicle occupant seated within the vehicle seat and the safety restraint device in the unlatched condition will generate a high voltage signal which is indicative of an unrestrained vehicle occupant. In a preferred embodiment, the logic circuit 34 includes dual logic gates (i.e., NAND gates) for generating the alert output signal. The table shown in FIG. 4 illustrates inputs and associated outputs for the logic circuit shown in FIG. 3. Alternatively, it is understood that the voltage logic signals may be switched for identifying the seated occupant and the seat belt unlatched and the logic circuit 34 may include a single AND gate or other gate which outputs an alert output signal identifying the unrestrained vehicle occupant only when the resulting output occupant signal indicates that a vehicle occupant is seated within the vehicle seat 16 and the resulting safety restraint signal indicates that the safety restraint device is in an unlatched condition. It is noted that other various types of logic gates or other comparative circuits may be utilized without departing from the scope of the invention.

Since the alert output signal is in the form of either a 5 volt or 0 volt signal, an A/D conversion is not required. That is, typically prior art systems utilize one or more sensed signals from a respective occupant sensing circuit which require A/D conversion prior to being input to the controller for processing. Similarly, a seat belt restraint device may require analog to digital conversion prior to being input to the controller for processing. A prior art controller would typically process the incoming converted signals and determine if an unrestrained vehicle occupant is present. The present invention eliminates the need for addition A/D converters by processing the data received from the occupant sensing circuit and the seat belt restraint device and outputting an alert output signal which is indicative of the presence of the unrestrained vehicle occupant. Additional processing by the safety control module for determining if an unrestrained vehicle occupant is present is not required; rather the alert output signal is indicative of presence of the unrestrained vehicle occupant for initiating a warning to the unrestrained vehicle occupant. In addition, a resistance output circuit 36 is provided for converting the alert output signal (voltage) to a resistance value. The resistance output value may be utilized when the controlling device (i.e., safety control module) receiving the output signal requires a resistance value as opposed to a voltage signal.

The resistance output circuit 36, shown in FIG. 3, is only one of many conversion circuits which may be used for converting the voltage signal to a resistance output value. A transistor 50, a first resistor 52, and a second resistor 54 are provided for converting the alert output signal to a desired resistance value based on the in response to the alert output signal. Alternatively, other suitable electrical devices other than a transistor, such as a FET or other appropriate switching device or devices may be utilized. The first resistor 52 and the second resistor 54 are electrically connected to a 5 volt input source. If the alert output signal output from the logic circuit 34 is a low voltage signal (0 volts) thereby indicating that no vehicle occupant is present or the vehicle occupant is restrained, the transistor 50 will remain off. Both combined resistance values of the resistance output circuit 36 as measured at the resistance output 56 includes the summed resistance value of the first resistor 52 and the second resistor 54. The combined resistance value indicates an unoccupied vehicle seat (or a restrained vehicle occupant is present) and no alert warning indication is necessary. If the alert output signal is a high voltage signal (5 volts) indicating the presence of an unrestrained vehicle occupant, the transistor 50 will turn on. The second resistor 54 is short-circuited within the resistance output circuit 36. As a result, the resistance output value will include only the resistance value of the first resistor 52. A resistance output value substantially equal to the first resistor indicates that an unrestrained vehicle occupant is present in the vehicle seat.

It should be noted that the above resistance output circuit is only one embodiment for converting the output signal to a respective resistance value and that other circuits or electrical components, such as FETS and other electrical devices or circuit architectures may be utilized to convert the alert output signal to a resistance value or any other type of signal as demanded by the safety control module 38.

Preferably, each of the sensing circuits described above, namely, the occupant sensing circuit, logic circuit, seat belt restraint sensing circuit, and the resistance output circuit may be integrated on a single printed circuit board. Moreover, any combination of the above mentioned circuits may be integrated on one or more circuit boards.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle restraint occupant sensing system for detecting a presence of an unrestrained vehicle occupant in a vehicle seat comprising:
a seat belt restraint sensing circuit for sensing whether a seat belt is in an unlatched condition;
an occupant sensing system including at least one sensor assembly in spaced relation to a vehicle seat for sensing a presence of the occupant in the vehicle seat, the occupant sensing system including a comparator circuit coupled to the at least one sensor assembly and the seat belt restraint sensing circuit for producing an output signal indicative of the presence of the occupant; and
a logic circuit disposed within the vehicle seat coupled to an output of the comparator circuit and the seat belt restraint sensing circuit for providing an alert output signal when the seat belt is in the unlatched condition and the output signal indicates that the occupant is present.

2. The system of claim 1 further comprising a resistance output circuit coupled to the logic circuit for generating the alert output signal as a resistance output value.

3. The system of claim 1 wherein the occupant sensing system includes a plurality of sensor assemblies disposed adjacent a lower surface of the vehicle seat cushion for variably sensing a displacement of the vehicle seat cushion for identifying a presence of the occupant in the vehicle seat.

4. The system of claim 3 wherein outputs of the plurality of sensor assemblies are summed to provide a summed output signal to the comparator circuit.

5. The system of claim 3 wherein outputs of the plurality of sensor assemblies are averaged to provide an averaged output signal to the comparator circuit.

6. The system of claim 3 wherein the occupant sensing system includes a mat sensor array assembly.

7. The system of claim 1 wherein the comparator circuit and the logic circuit are integrated on a printed circuit board.

8. The system of claim 7 wherein the seat belt restraint sensing circuit is integrated on the printed circuit board.

9. The system of claim 7 further comprising a printed circuit board wherein the resistance output circuit is integrated on the printed circuit board.

10. A method for detecting an unrestrained vehicle occupant seated on a vehicle seat of a vehicle, the method comprising the steps of:
providing a seat belt restraint sensing circuit, an occupant sensing circuit, and a logic circuit, each being disposed adjacent a lower surface of the vehicle seat cushion;
sensing whether a seat belt is in an unlatched condition;
sensing a presence of the occupant in the vehicle seat;
determining in the logic circuit whether a vehicle occupant is unrestrained in response to the sensing an unlatched seat belt while the presence of the occupant in the vehicle seat is sensed; and
outputting an alert output signal to a controller module remote from the vehicle seat indicative of an unrestrained vehicle occupant.

11. The method of claim 10 wherein outputting the alert output signal is adapted to be used for alerting a safety restraint module of an unrestrained vehicle occupant.

12. The method of claim 10 further comprising the step of inputting the alert output signal to a resistance output circuit for producing a resistance value.

13. The method of claim 12 wherein the controller module is a safety restraint module.

14. The method of claim 12 wherein the seat belt restraint sensing circuit, the occupant sensing circuit, and the logic circuit are integrated on a printed circuit board.

15. The method of claim 14 wherein the resistance output circuit is integrated on the printed circuit board.

16. The method of claim 10 wherein the occupant sensing circuit includes a plurality of sensor assemblies, wherein sensed output signals from the plurality of sensor assemblies are combined for producing an output signal, the output signal being provided to a comparator.

17. The method of claim 16 wherein the sensed output signals are summed for producing a summed output signal.

18. The method of claim 16 wherein the sensed output signals are averaged for producing an averaged output signal.

19. The method of claim 16 wherein the comparator outputs a resulting output signal indicating a presence of the vehicle occupant seated in the vehicle seat.

20. The method of claim 16 wherein the comparator outputs a resulting output signal indicating an absence of the vehicle occupant in the vehicle seat.
